(19) United States
(12) Patent Application Publication
(10) Pub. No.: US 2007/0045337 A1
(43) Pub. Date: Mar. 1, 2007

(54) Dispensing device

(76) Inventors: James Russell Hornsby, St. Louis, MO (US); Marcellus Rambo Benson, Chesterfield, MO (US); James Augustus Keefe III, O'Fallon, MO (US); Joseph Lee McGowan, St. Charles, MO (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/472,805

(22) Filed: Jun. 22, 2006

Related U.S. Application Data
(60) Provisional application No. 60/693,848, filed on Jun. 24, 2005.

(51) Int. Cl. B67D 5/08

(52) U.S. Cl. 222/63

(57) ABSTRACT

A dispensing device including a housing, a container portion for containing a substance to be dispensed, a nozzle portion, a dispensing mechanism and a power source for providing power to the dispensing mechanism, wherein, when actuated, the dispensing mechanism causes the substance to move from the container and through the nozzle.

### CROSS-REFERENCE TO RELATED APPLICATION(S)

This application claims priority to U.S. provisional patent application Ser. No. 60/693,848, filed Jun. 24, 2005, which is incorporated herein by reference in its entirety.

### BACKGROUND

The present invention relates to devices for dispensing, applying or delivering substances, and to methods of making and using such devices. More particularly, the present invention relates to a device for dispensing a substance such as an insecticide, and to a method of making and using the dispensing device.

### SUMMARY

In one embodiment, the present invention comprises a dispensing device, suitable for various uses, which provides ease and accuracy of use.

In one embodiment, the present invention provides a dispensing device, suitable for various uses, wherein the device and/or components thereof are adapted to dispense, apply, eject, deliver or administer a selected substance, for example an insecticide or a cleaning agent, wherein the device comprises a dispensing mechanism and a power source for powering the dispensing mechanism for a more efficient and convenient dispensing of the substance. An advantage of the present invention is that it provides for accurate application of a substance as well as for reduced or lower user or use effort.

In one embodiment, the present invention comprises a dispensing device, suitable for dispensing a selected substance, comprising a housing, and on-board power source, a container portion for containing a substance to be dispensed, a nozzle or tip portion and a dispensing mechanism. When actuated, the dispensing mechanism acts to force or eject the substance from the container and through the nozzle onto or into an intended target or target surface. For example, in one embodiment, the device may be used to deposit an insecticide on a target surface.

In some embodiments, the present invention may be used to dispense and/or apply a gel insecticide or insect repellent.

In some embodiments, the present invention comprises a portable, handheld, non-aerosol, motorized dispenser for dispensing or applying substances such as insecticides or insect repellents or the like that are currently sold in and/or dispensed from manually driven plunger-type devices.

In one embodiment, the present invention comprises a dispenser for dispensing or applying a substance, the dispenser comprising a housing, a nozzle tip, a battery, a battery operated motor, a container and a dispensing mechanism, wherein actuating the motor causes the dispensing mechanism to dispense the substance from the container through the nozzle tip. The invention may take the form of a reusable or refillable, or disposable item. In some embodiments, an emptied container or a cartridge of material to be dispensed may be replaced or the container or cartridge may be refilled and reinserted in the device.

In one embodiment, the present invention comprises a generally tubular body containing a substance to be dispensed or applied and a dispensing mechanism for forcing the substance from the body. A button or touch actuator is provided on the body and, when pushed or touched, an on-board motor turns a screw shaft to move a piston which acts on the substance to force it out of the body.

The motor and/or shaft may be selectively adapted, e.g., geared, pitched, etc., depending on the characteristics, e.g., viscosity, cure time, etc., of the substance to be dispensed. The dispensing mechanism, which in one embodiment comprises the motor, screw shaft and piston may also be adapted to dispense or apply a selected substance at a selected rate. The container, container portion or body and the nozzle, i.e., any component of the device that could contact the substance to be dispensed, may be selectively adapted to characteristics of the substance, e.g., corrosiveness, viscosity, liquidity, etc.

In some embodiments the present invention may be adapted for dispensing food items, candy, condiments, cleaning agents (e.g., grout cleaner, bleach or a laundry gel), coatings, colorants, or other selected substances or materials.

### BRIEF DESCRIPTION OF THE DRAWINGS

FIG. 1 is a perspective view of an embodiment of the present invention.

FIG. 2 is a perspective view of the other side of the embodiment depicted in FIG. 1.

FIG. 3 is an exploded view of an embodiment of the present invention.

FIG. 4 is an elevational view of an embodiment of the present invention.

FIG. 5 is a sectional view taken along line C-C of FIG. 4.

FIG. 6 is an end view of the embodiment depicted in FIG. 4.

FIG. 7 is a cross sectional view of the embodiment of the present invention depicted in FIG. 4.

FIG. 8 is a representational view of another embodiment of the present invention.

### DETAILED DESCRIPTION

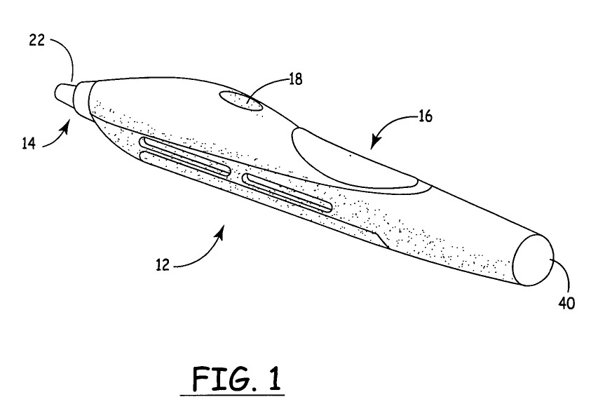

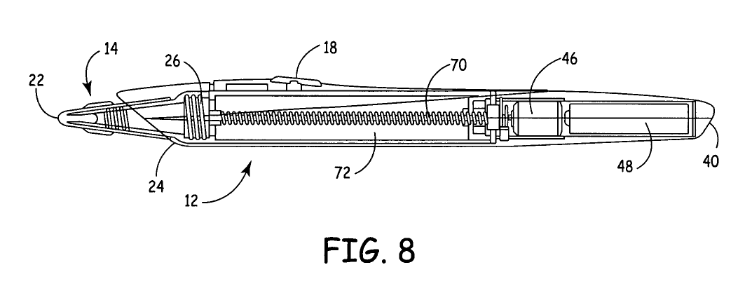

The accompanying figures (FIGS. 1-8) and this description depict and describe embodiments of a dispensing device and/or embodiments of features and components of such a device in accordance with the present invention. The present invention also encompasses a method of making and using embodiments of a dispensing device, and/or making and using embodiments of components of the device.

With regard to fastening, mounting, attaching or connecting components of the present invention to form the device or component parts thereof, unless specifically described otherwise, such are intended to encompass conventional fasteners such as screws, threaded connectors, snap rings, detailed arrangements, clamps, etc. Components may also be connected by suitable adhesives, glues, welding, including ultrasonic welding, and friction fitting or defamation. Appropriate liquid, fluid and/or airtight seals or sealing devices and/or fastening of methods may be used. Any electronic portions of the present invention may use commercially available electronic components, connectors and devices such as suitable wiring, connectors, printed circuit boards, microprocessors (if used, e.g., see FIG. 6, and microprocessor “M”), microchips, sensors, inputs, outputs, switches, power sources, etc. Unless specifically otherwise disclosed or taught, materials for making the present invention and/or components thereof may be selected from appropriate materials such as metal, metallic alloys, ceramics, plastics and the like, and appropriate manufacturing or production methods including casting, molding, pressing, extruding and machining may be used.

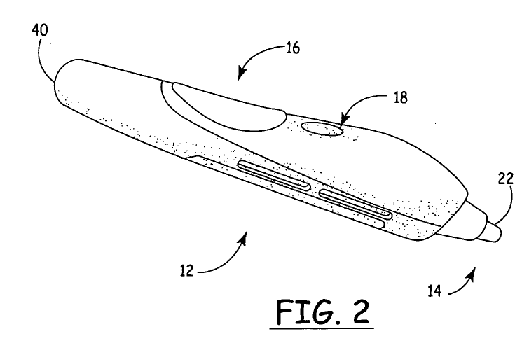

Referring to the FIGS. 1 and 2, the present invention comprises a dispensing device 12. The device includes a working end 14 and a gripping portion 16, with an actuation or on/off switch 18 located near the gripping portion. Generally, the device 12 in accordance with the present invention comprises a pen-like dispensing device adapted to be handheld and suitable for dispensing a substance therein or for applying a material contained therein to a selected surface.

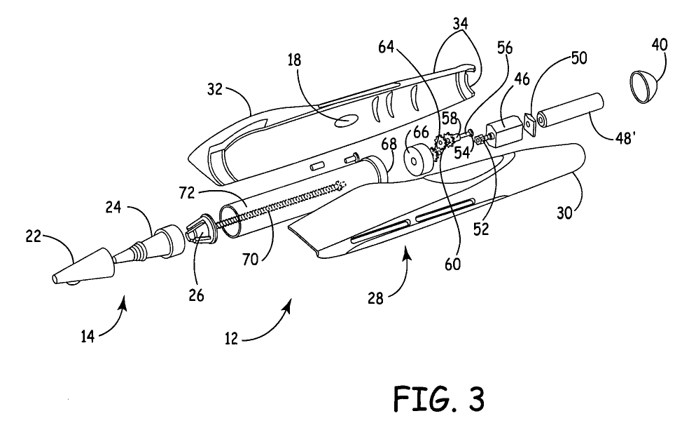

FIG. 3 is an exploded assembly view of the embodiment of the invention depicted in FIG. 1. The working end 14 comprises a screw on cap 22 adapted to be connected to the body of the device 12 to cover a tip 24. A connecting body 26 is adapted to be received in the cap 22 and tip 24 arrangement.

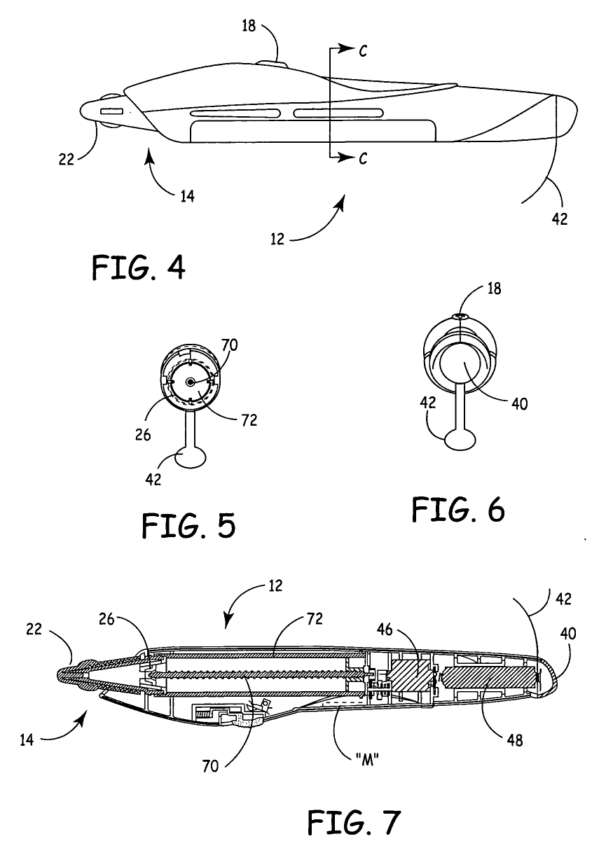

The body 28 is formed by a left side shroud 30 and a right side shroud 32. The shrouds 30, 32 are clam shell type body components adapted to be connected to each other to form a hollow interior for containing and/or supporting further components of the device. The shrouds 30, 32 may be provided with internal support frame structures 34 as necessary. When brought together, the shrouds 30, 32 provide a body or housing for housing components of the present invention, and also provide an opening 36 for receiving the actuation button or switch 18. The rear end of the body 28 may be closed by a suitable cover 40. In some embodiments, the cover 40 may comprise a removable battery access hatch that can be appropriately connected to the body 28 and, as depicted in FIGS. 4-7, the present invention may comprise a pull tab of 42 or other suitable removing or access structure for detaching the cover 40 from the body of the device to change a battery.

With further reference to FIG. 3, internal operating components of the dispensing device 12 are depicted. These components comprise a dispensing mechanism and include a motor 46 carried generally toward the rear end of the gripping portion of the device 12. The motor 46 may be selected from any one of a number of commercially available electric motors, e.g., a standard 2.5 v motor, such as an Action Motor, model AF 030SU-08250. Generally adjacent to the motor 46 is a power source 48, in this instance, a single triple AAA battery. Other power sources may be used as well. The battery 48 is coupled to the motor 46 through suitable contacts such as contact 50. At its output, the motor 46 carries or is coupled to a motor gear 52 which is in turn operably coupled to a clutch gear bearing 54 carried on a shaft 56. A suitable suspension spring or coupling spring 58 is mounted on the shaft 56 adjacent to a pair of clutch gears 60. The clutch gears 60 operably engage a drive gear 64 next to a shaft bearing 66. A dispensing piston 68 is carried or operably coupled to the gear shaft 56 and is carried by a screw shaft 70. As can be seen from FIG. 3 the screw shaft 70 is located generally centrally in and coaxial with a container 72 for containing a material to be dispensed, and is supported, generally, at the working end, by connector body 26. The container 72 may be a separate replaceable or refillable unit, or it can be formed integrally by the left and right shrouds of the device 12.

It should be appreciated that the device 12 may be designed as a single use or disposable product or a refillable, reusable product. In the latter instance, the container 72 may be replaced or refilled as necessary, and the battery 48 may be replaced or recharged as necessary. Additionally, cartridges or containers containing various or selected substances may be substituted or used in the device, as can a selected tip, tip material, tip/cover arrangement or nozzle at the working end 14. Thus, the device may be adapted as might be desirable or applicable for a selected substance to be dispensed, a selected pattern of application or a selected rate of dispensing. Further, it could be adapted to apply, dispense and/or combine a multipart formulated substance, e.g., a two part epoxy, etc., wherein at least two components, each in a separate container or cartridge, or separate part of a cartridge, are mixed and dispensed at the point of application.

The actuation or control switch 18, which may take the form of a touch type switch, a slide switch, a press on/off button or other suitable switch, may be operably carried by the housing of the device 12.

FIGS. 4-7 depict another embodiment of the dispensing device of the present invention. Components similar to those shown in FIG. 3 are similarly numbered. FIG. 4 is a elevational view depicting an embodiment having a tab 42 for accessing a battery compartment. FIG. 5 depicts a sectional view of the present invention, particularly showing the coaxial arrangement of components including the screw shaft, the container and the housing or body formed by the two shrouds. FIG. 6 is an end elevational view showing how the tab 42 underlies the battery cover for accessing the battery compartment to, for example, change the battery. FIG. 7 is a sectional view of the embodiment to FIG. 4 depicting the relationship and mounting of the components. It should be appreciated that suitable wiring is used to operably couple the electrical components of the present invention, e.g., on/off switch, the motor and the power source, i.e., the battery.

It should be understood that any appropriate material may be selected for making the device of the present invention or any of the components thereof. Such materials include appropriate metallic alloys, e.g., alloys of nickel, or plastics, e.g., ABS, high density polyethylene, POMS (polyoxometalates), etc.

While multiple embodiments of the present invention, including preferred embodiments, are described, still other embodiments and/or aspects of the present invention will become apparent to those skilled in the art from the accompanying figures and the description, which show and describe a illustrative embodiments of the invention as will be realized, the invention is capable of modification in various aspects, all without departing from the spirit and scope of the invention. Accordingly, the drawings and description are to be regarded as illustrative, not restrictive.

1. A dispensing device comprising a housing, a container portion for containing a substance to be dispensed, a nozzle portion, a dispensing mechanism and a power source for providing power to the dispensing mechanism, wherein, when actuated, the dispensing mechanism causes the substance to move from the container and through the nozzle.

2. The dispensing device according to claim 1, wherein the dispensing mechanism comprises a motor, an output shaft, a transmission coupled to the output shaft, a screw shaft coupled to the transmission and a piston carried by the screw shaft.

3. The dispensing device according to claim 1, wherein the substance is an insecticide or insect repellant.

4. The dispensing device according to claim 2, further comprising a container removeably received in the container portion.

5. The dispensing device according to claim 2, further comprising an actuator for actuating the dispensing mechanism, the actuator operably coupled to the motor and power source, whereby when the dispensing mechanism is actuated, the screw shaft turns to move the piston to move the substance through the nozzle.

6. A dispensing device comprising a generally tubular body carrying a nozzle at one end, said body containing a substance to be dispensed and a dispensing mechanism for forcing the substance out of the body, the dispensing mechanism comprising a motor, a screw shaft operably coupled to the motor and a piston carried by the screw shaft, whereby, when the motor is actuated, the piston is moved along the screw shaft to force the substance through the nozzle.
